(19) United States
(12) Patent Application Publication
(10) Pub. No.: US 2010/0083249 A1
(43) Pub. Date: Apr. 1, 2010

(54) Managing diverse hardware using common tools

(75) Inventors: Ranjan K. Gupta, Salt Lake City, UT (US); Kattiganehalli Y. Srinivasan, Princeton Junction, NJ (US); Scott A. Isaacson, Kamuela, HI (US)

Correspondence Address: KING & SCHICKLI, PLLC, 247 NORTH BROADWAY, LEXINGTON, KY, 40507, US

(73) Assignee: Novell, Inc.

(21) Appl. No.: 12/286,305

(22) Filed: Sep. 29, 2008

(51) Int. Cl. G06F 9/455

(52) U.S. Cl. 718/1

(57) ABSTRACT

Methods and apparatus involve managing a plurality of hardware platforms with common tools despite actual or potential non-uniformity of vendor items. Representatively, hardware platforms include a minimalist operating system upon which a management agent and vendor-specific providers are deployed. From a console common to the platforms, local or remote management occurs. In a paradigm shift when initially deploying or redeploying platforms, for example, a “just enough” operating system exists to configure the hardware of different vendors so virtual machines can be thereafter deployed without needing pre-configured operating systems, bundled management packages, etc. A common embedded hypervisor on the platform is but one technique to achieve a minimalist operating system as is a common CIMOM or SNMP agent but one technique to achieve a management agent. Other features include computing systems and computer program products, to name a few.

### FIELD OF THE INVENTION

Generally, the present invention relates to computing devices and computing environments involving management of hardware platforms. Particularly, although not exclusively, it relates to centralized management of those platforms, each with potentially non-uniform vendor tools, code, agents, etc., and doing so with tools commonly deployed in other uses or specialties. Other features contemplate computing systems and computer program products, to name a few.

### BACKGROUND OF THE INVENTION

As is presently known, enterprises and individuals manage their computing hardware using vendor specific tools that require vendor specific code on the machine. These tools can be run locally via a dedicated keyboard/monitor interface or can be run remotely via a dedicated vendor specific network stack on a network interface. The tools are useful in undertaking a variety of tasks, such as setting or changing partition sizes, boot order, system clocks, BIOS settings, etc., configuring the hard disk, or for making general diagnosis, repair, add/remove actions and other activities. Ubiquitously, there are vendor specific agents and tools for even the most basic tasks. They come pre-loaded on a computing device oftentimes or bundled in a package available as a download or on installation disks that arrive with a new device. While this paradigm works somewhat acceptably for a single computing device, or in instances where multiple devices coexist from a single vendor, it becomes complicated as vendors upgrade or change versions of devices. Certainly, it unacceptably fails in situations involving multiple machines from multiple different vendors.

Its failure is also compounded as multiple different devices are upwardly scaled into larger connections and networks, such as is regularly found in an enterprise data center. As skilled artisans will appreciate, each device having its own vendor-provided agents/tools/etc. becomes overly complex in interfacing, understanding, compatibility, etc., as the machines grow in number from a few machines to dozens, or hundreds or more. With the advent of virtual computing environments, many virtual machines are guested on a single hardware platform, including each with its own operating system, drivers, interfaces, applications, etc. Carrying forward the model of vendor-specific agents/tools/etc. per each vendor item, the problem is only exacerbated when trying to interface, provide compatibility, learning, etc.

Still further, as virtual environments are redeployed during their life to accomplish new or different services for the enterprise, the underlying hardware platforms are often found without an installed operating system. In turn, management of the hardware is quite difficult, but installing a monolithic operating system certainly represents overkill for commonplace management tasks, especially considering the lack of an application environment per the virtual machines.

Accordingly, a need exists in the art of managing hardware for simple solutions when actual or potential non-uniformity of vendor items exists. The need further extends to situations involving computing devices without satisfactory operating systems and, perhaps, to a paradigm shift in the manner in which new computing devices are originally bundled for customers. Appreciating many tools already exist in the marketplace, being able to leverage one or more of these in accomplishing the foregoing, instead of relying entirely on developing wholly new techniques, is but another way to achieve advantage over the state of the art. Naturally, any improvements along such lines should further contemplate good engineering practices, such as ease of implementation, unobtrusiveness, security, stability, etc.

### SUMMARY OF THE INVENTION

The foregoing and other problems become solved by applying the principles and teachings of the hereinafter-described managing diverse hardware using common tools. At a high level, methods and apparatus involve managing one or more hardware platforms with non-uniform vendor items and doing so with common tools typically useful in other applications. That is, features of the invention contemplate the use of a minimalist operating system (pDistro), usually designed for hosting and managing virtual machines (vDistro), as a way to also realize managing hardware platforms with common tools rather than using vendor specific tools.

In a paradigm shift, when initially deploying or redeploying platforms, for example, a “just enough” operating system is deployed on hardware platforms from different vendors and without knowledge or care of an application environment of the virtual machines. Thereafter, a management agent and vendor-specific providers are deployed so that a user can locally or remotely manage the hardware from a console common to the platforms. An embedded hypervisor fulfills the “just enough” OS requirement, but is also able to host full application oriented virtual machines (vDistros) during regular use, if desired. Similarly, a common information model object manager (CIMOM) (or other standards-based management agent) along with vendor specific drivers needed to run the computing device (the pDistro) are deployed in order to locally or remotely manage the hardware. In this manner, the most basic elements of the system are modeled not only as hardware with no monolithic operating system, and additional general purpose software operating on top of that, but are modeled with an embedded “just enough” OS to run standards based management software where the additional application OS's are run as virtual machines. While this does result in some necessary vendor specific code, the management agent providers use that code rather than the tools with vendor specific UI and other functionality. Ultimately, the hardware of the different vendors is configurable without needing pre-configured operating systems or pre-bundled management packages.

Executable instructions loaded on one or more computing devices for undertaking the foregoing are also contemplated as are computer program products available as a download or on a computer readable medium. The computer program products are also available for installation on a network appliance or discrete computing devices.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance in accordance with the present invention for managing diverse hardware using common tools; and

FIG. 2 is a diagrammatic view in accordance with the present invention of an upwardly scaled FIG. 1.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for managing diverse hardware using common tools.

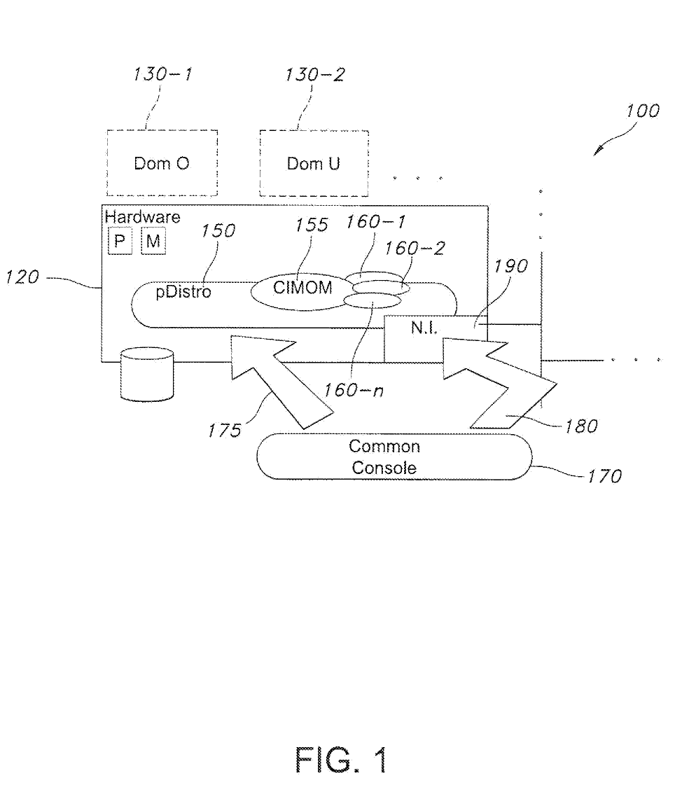

With reference to FIG. 1, a representative computing system environment 100 includes a hardware platform 120 for hosting a variety of virtual machines 130-1, 130-2, . . . etc. (vDistro). In turn, each virtual machine will include its own guest operating system, dedicated applications, etc., as is typical. However, to effectively provide management to the hardware platform in an actual or potentially non-uniform hardware environment, certain embodiments introduce the notion of a pDistro installed on the platform that manages the platform with common tools, across multiple different hardware vendors, with “just enough” operating system without caring about a full application environment for the virtual machines, proper pre-configuration of a monolithic operating system or bundled management packages.

In more detail, the pDistro 150 embodies an embedded hypervisor layer with generally low level system code having a sufficient enough operating system to conduct minimal activities, such as process management, scheduling events, enabling the setting or changing of partition sizes, boot order, system clocks, BIOS settings, etc., configuring the hard disk, or performing general diagnostics, repair, add/remove activities, and the like. It is not, however, necessary that the operating system have any full functionality, such as for the hosting of an application environment. To the extent it does, the foregoing can be done with just the minimalist kernal described.

Once installed, the embedded hypervisor has installed thereon a management agent 155, such as a common information model object manager (CIMOM) (or other standards-based management agent, e.g., HP Open View Tivoli, an SNMP agent, etc.), along with management agent providers 160-1, 160-2, . . . 160-n in communication therewith. Thence, from a console 170, the hardware platform can be effectively managed in a local instance 175 or remotely 180, by way of a network interface (N.I.) 190. While there is still some necessary vendor specific code, it is the management agent providers that use the code rather than, as in the prior art, the tools with vendor specific UI and other functionality.

As a result, management of one or more hardware platforms with actual or potentially non-uniform vendor items is done with tools common in other applications. That is, features of the invention use of a minimalist operating system (pDistro), usually designed for hosting and managing virtual machines (vDistro), as a way to also realize managing hardware platforms. Thereafter, a management agent and vendor-specific providers are deployed so that a user can locally or remotely manage the hardware from a console common to the platforms. An embedded hypervisor fulfills the “just enough” OS requirement, but is also able to host full application oriented virtual machines (vDistros) during regular use, if desired. Similarly, a common information model object manager (CIMOM) (or other standards-based management agent) along with vendor specific drivers needed to run the computing device (the pDistro) are deployed in order to locally or remotely manage the hardware.

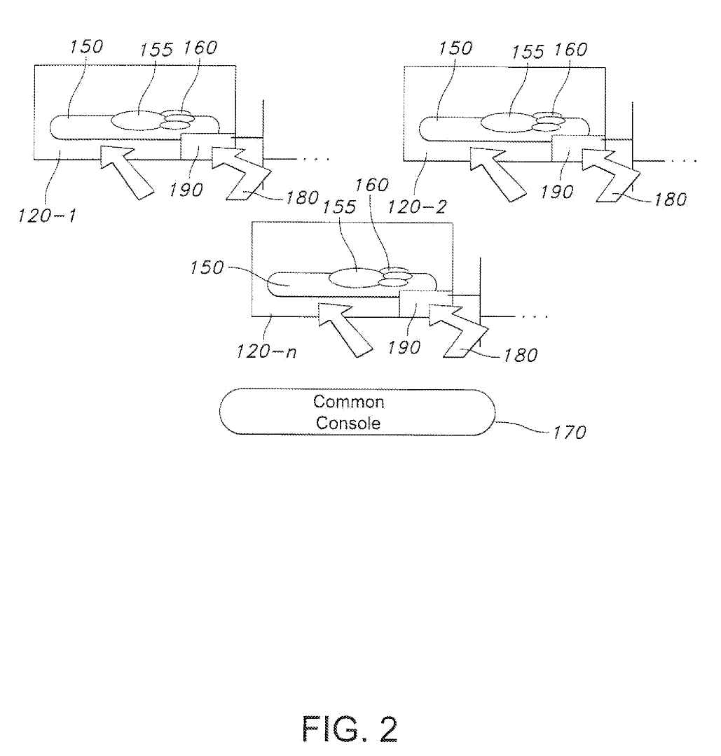

With reference to FIG. 2, the upward scalability of FIG. 1 can be seen in the computing environment such that pluralities of virtual machines 120-1, 120-2, . . . 120-n can each have their minimalist OS 150, management agent 1550 and providers 160, and be remotely managed 180 by way of a console 170 common to each via respective network interfaces 190.

In either Figure, each of the hardware platforms 120 typify a computing device in the form of a server. They are of a future-defined or traditional type, such as a grid or blade server, and can fulfill any future-defined or traditional role, such as a web server, email server, database server, file server, etc. In network, they are arranged to communicate via their interface 190 with one or more other computing devices or networks, and skilled artisans readily understand the configuration. The servers may use wired, wireless or combined connections, to other devices/networks and may be direct or indirect connections. If direct, they typify connections within physical or network proximity (e.g., intranet). If indirect, they typify connections such as those found with the internet, satellites, radio transmissions, or the like. In this regard, other contemplated items include other servers, routers, peer devices, modems, Tx lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

In configuration, the virtual machines of the physical server can be arranged in a variety of ways, including architectures with a multiplicity of domains (dom0, domU) and a variety of operating systems (Host OS or Guest OS) (e.g., Linux, Windows, Netware, Unix, etc.), as is known. Also, the hardware platforms embody physical I/O and platform devices, memory (M) and a processor (P), such as a CPU, Disk, USB, etc., while the hypervisor (which is the virtual interface to the hardware and virtualizes the hardware), is the lowest and most privileged layer and manages conflicts, for example, caused by operating system access to privileged machine instructions. The hypervisor can also be type 1 (native) or type 2 (hosted). The physical distribution, or pDISTRO, is also typically functionally configured specifically for the hardware platform and used to deploy other features, such as drivers, agents, sound cards, etc., and may also include a file system or a directory service configured for the hardware.

In any embodiment, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads. When described in the context of such computer program products, it is denoted that components thereof, such as modules, routines, programs, objects, data structures, etc., perform particular tasks or implement particular abstract data types within various structures of the computing system which cause a certain function or group of function, and such products are generally well known in the art.

In still other embodiments, the foregoing is anticipated to be released in the form of a commercially available product having the name Novell Virtualization Platform. It will be useful in the context described above, but certainly for instances of redeployment of virtual machines, or for computing device vendors who desire to distribute new or refurbished computing devices with a minimalist operating system that can be managed locally or remotely to configure the hardware and thereafter install or build the virtual machines. Intuitively, no longer will it be necessary to provide fully pre-loaded computing devices or those bundled with management packages available as a download or on installation disks.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of managing a hardware platform upon which a plurality of virtual machines can be configured, comprising:
deploying on the hardware platform a minimalist operating system;
deploying on the minimalist operating system a management agent; and
deploying in communication with the management agent a plurality of vendor-specific providers, altogether the minimalist operating system, the management agent and providers being operable to allow a user to manage the hardware platform from a connected console despite an actual or potential non-uniformity of vendor items with the hardware platform.

2. The method of claim 1, wherein the deploying the management agent further includes deploying a CIMOM.

3. The method of claim 1, further including managing another hardware platform from the console common to both the hardware platform and the another hardware platform.

4. The method of claim 3, further including deploying another minimalist operating system on the another hardware platform that can support both another management agent and another plurality of vendor-specific providers.

5. The method of claim 3, wherein the hardware platform and the another hardware platform each have a network interface, further including communicating with the network interface from the console.

6. The method of claim 1, wherein the deploying the minimalist operating system further includes installing a hypervisor on the hardware platform.

7. The method of claim 1, wherein the operability to allow the user to manage further includes allowing configuring a hard disk and partition sizes for the virtual machines, setting a boot order, setting a system clock or setting BIOS settings.

8. In a computing system environment, a method of managing a plurality of hardware platforms upon which a plurality of virtual machines can be configured, comprising:
deploying on the each said hardware platform a minimalist operating system;
deploying on each of the minimalist operating systems a management agent;
deploying in communication with each of the management agents a plurality of vendor-specific providers; and
managing the plurality of hardware platforms from a console common to the each said hardware platform despite an actual or potential non-uniformity of vendors with any of the hardware platforms.

9. The method of claim 8, wherein the each said hardware platform has a network interface, the managing occurring from the console by way of the network interface.

10. The method of claim 8, wherein the deploying the minimalist operating system further includes installing a hypervisor on the each said hardware platform.

11. The method of claim 8, wherein the deploying the management agent further includes deploying a CIMOM or an SNMP agent.

12. In a computing system environment, a method of managing a plurality of hardware platforms upon which a plurality of virtual machines can be configured, each said hardware platform having no functional operating system before configuration of the virtual machines, comprising:
deploying on the each said hardware platform a hypervisor to provide the each said hardware platform a minimalist operating system;
deploying on each of the hypervisors a CIMOM;
deploying in communication with each of the CIMOMs a plurality of vendor-specific providers; and
managing the plurality of hardware platforms from a console common to the each said hardware platform despite an actual or potential non-uniformity of vendor items with any of the hardware platforms.

13. A computing device, comprising:
a hardware platform, including a processor, memory and available storage upon which a plurality of virtual machines can be configured;
a hypervisor layer on the hardware platform providing a minimalist operating system to the hardware platform;
a management agent deployed on the minimalist operating system;
a plurality of vendor-specific providers deployed in communication with the management agent; and
a console for a user to manage the hardware platform despite an actual or potential non-uniformity of vendor items therewith.

14. The computing device of claim 13, further including a network interface by which the console can manage other hardware platforms.

15. The computing device of claim 13, wherein the management agent is a CIMOM or an SNMP agent.

16. The computing device of claim 13, wherein the hypervisor layer further includes scheduling control for the virtual machines each operating as an independent guest computing device on the processor and memory.

17. A computing system, comprising:
a plurality of hardware platforms each including a processor, memory and available storage upon which a plurality of virtual machines can be configured, the each of the hardware platforms further including a network interface;
a hypervisor layer on the each of the hardware platforms providing a minimalist operating system;
a management agent deployed on each of the minimalist operating systems;
a plurality of vendor-specific providers deployed in communication with each of the management agents; and
a common console for a user to remotely manage the hardware platforms despite an actual or potential non-uniformity of vendor items with the hardware platforms, the common console configured to connect to the network interfaces of the hardware platforms.

18. A computer program product available as a download or on a computer readable medium for loading on a computing device in a computing system environment to manage a plurality of hardware platforms upon which a plurality of virtual machines can be configured, the computer program product having executable instructions, comprising:
a first component to deploy on each said hardware platform a minimalist operating system;
a second component to deploy on each of the minimalist operating systems a management agent; and
a third component to configure in communication with each of the management agents a plurality of vendor-specific providers to manage the plurality of hardware platforms from a console common to the each said hardware platform despite non-uniformity of vendor items in any of the hardware platforms.

19. The computer program product of claim 18, wherein the first component is configured to deploy the minimalist operating system by installing a hypervisor on the each said hardware platform.

20. The computer program product of claim 18, wherein the second component is configured to deploy the management agent as CIMOM.
